(19) United States
(12) Patent Application Publication
(10) Pub. No.: US 2018/0290683 A1
(43) Pub. Date: Oct. 11, 2018

(54) METHOD FOR OPERATING A MOTOR VEHICLE

(71) Applicant: Dr. Ing. h.c. F. Porsche Aktiengesellschaft, Stuttgart (DE)

(72) Inventor: Andreas Munzert, Gerlingen (DE)

(73) Assignee: Dr. Ing. h.c. F. Porsche Aktiengesellschaft, Stuttgart (DE)

(21) Appl. No.: 15/946,855

(22) Filed: Apr. 6, 2018

(30) Foreign Application Priority Data
Apr. 10, 2017 (DE) 102017107603.4

(51) Int. Cl. B62D 7/15; B60T 8/1761

(52) U.S. Cl. CPC B62D 7/159; B60T 8/1761; B60T 2201/16; B60G 2400/61; B60G 2800/952; B60G 2800/215

(57) ABSTRACT

A method for operating a motor vehicle which is equipped with a driving dynamics control system by which individual wheels of the motor vehicle can be braked in a targeted manner. In order to prevent the occurrence of undesirable noises during maneuvering of the motor vehicle, during a maneuvering operation, in which two front wheels are turned with a large wheel lock, wherein friction occurs at the front wheels because of ground contact, one of the wheels is influenced in a targeted manner in order to pull or to force the motor vehicle onto a smaller turning circle during the maneuvering.

### CROSS-REFERENCE TO RELATED APPLICATION

This application claims priority to German Patent Application No. DE 10 2017 107 603.4, filed Apr. 10, 2017, which is incorporated by reference herein in its entirety.

### FIELD OF THE INVENTION

The invention relates to a method for operating a motor vehicle which is equipped with a driving dynamics control system by means of which individual wheels of the motor vehicle can be braked in a targeted manner. The invention furthermore relates to a driving dynamics control system for operating a motor vehicle.

### BACKGROUND OF THE INVENTION

European laid-open application EP 0 992 373 A2, which is incorporated by reference herein, discloses a method for shortening the braking distance and improving the traction of a motor vehicle which has a roll stabilization system with at least one actuator drive on at least one axle, which actuator drive is arranged between the two halves of a chassis stabilizer, wherein the actuator drives on the axles are tensioned diagonally in an opposite direction such that contact forces of the wheels are increased or decreased according to different measured coefficients of friction, in order to permit shortening of the braking distance and improvement of the traction using the roll stabilization system in the case of carriageway surfaces which have different degrees of grip on the left-hand side and the right-hand side. German laid-open application DE 10 2008 048 222 A1, which is incorporated by reference herein, discloses a steering device for adjusting an angle of wheel lock of at least one rear wheel on a motor vehicle, wherein the steering device is activated in such a manner that the latter sets a toe-in or a toe-out at least one wheel of the rear axle. German laid-open application DE 40 15 974 A1, which is incorporated by reference herein, discloses a steerable motor vehicle rear axle with rigid lateral longitudinal links which support non-steerable wheels and are coupled at their front ends, which are remote from the wheels, in a pivotable manner to the vehicle body via rubber-elastic bearings and are connected to one another by means of a transverse strut which act in each case on said longitudinal links in a dimensionally rigid manner and can be twisted about their longitudinal axis, wherein, by means of an actuator element which pivots the longitudinal links, it is possible to generate a steering movement of the wheels which is in the opposite direction or in the same direction with respect to the steering movement of the front wheels, as a function of operating parameters of the vehicle.

German laid-open application DE 10 2008 003 901 A1, which is incorporated by reference herein, discloses a method for setting the wheel loads on a two-track, two-axle motor vehicle which is provided with a suitable system for changing the wheel load distribution, in particular using what are referred to as active stabilizers, wherein in the case of different coefficients of friction on the two vehicle sides, the vehicle axles are tensioned in opposite directions in that, on the first axle, the vertical load of the wheel is increased on the first vehicle side, and the vertical load of the wheel is decreased on the second vehicle side, while on the second axle the vertical load of the wheel is decreased on the first vehicle side and the vertical load of the wheel is increased on the second vehicle side.

### SUMMARY OF THE INVENTION

It would be desirable to prevent the occurrence of undesirable noises during maneuvering, in particular during entering and leaving parking spaces, by a motor vehicle which is equipped with a driving dynamics control system by means of which individual wheels of the motor vehicle can be braked in a targeted manner.

Disclosed herein is a method for operating a motor vehicle which is equipped with a driving dynamics control system by means of which individual wheels of the motor vehicle can be braked in a targeted manner, in that during a maneuvering operation, in which two front wheels are turned with a large wheel lock, wherein friction occurs at the front wheels because of ground contact, one of the wheels is influenced in a targeted manner in order to pull or to force the motor vehicle onto a smaller turning circle during the maneuvering. The maneuvering operation is preferably a parking operation, that is to say an operation of entering a parking space or leaving a parking space with the motor vehicle. A large wheel lock is understood as meaning turning, in particular maximum turning, of the steering system, as is carried out, for example, when entering a parking space or when maneuvering into a parking bay. By means of the targeted influencing of one of the wheels during the maneuvering operation, the turning circle of the motor vehicle can be optimized in a simple manner. During the targeted influencing or manipulation of one of the wheels, the wheel concerned is, for example, braked or acted upon with a changed driving torque. As a result, an undesirable hopping of one of the front wheels is particularly advantageously prevented during the maneuvering of the motor vehicle.

A preferred exemplary embodiment of the method is characterized in that a rear wheel on the inside of the bend is braked in a targeted manner during the maneuvering process in order to reduce skewing of a front wheel on the outside of the bend. As a result, a phenomenon which is undesirable during maneuvering and is also referred to as parking judder can be prevented or at least reduced. The occurrence of undesirable noises during maneuvering is prevented in particular by the fact that an intermittent slipping of the front wheel on the outside of the bend is suppressed by the targeted reduced driving of the rear wheel on the inside of the bend. The targeted braking of the rear wheel on the inside of the bend is advantageously initiated with the aid of the vehicle-internal driving dynamics control system.

A further preferred exemplary embodiment of the method is characterized in that a rear wheel on the inside of the bend is driven in a targeted manner with a lower driving torque during the maneuvering operation in order to reduce skewing of a front wheel on the outside of the bend. As a result, a phenomenon which is undesirable during maneuvering and is also referred to as parking judder can be prevented or at least reduced. The occurrence of undesirable noises during maneuvering is prevented in particular by the fact that an intermittent slipping of the front wheel on the outside of the bend is suppressed by the targeted reduced driving of the rear wheel on the inside of the bend. The targeted changing of the driving torque is advantageously initiated with a vehicle-internal control system for distributing torque. The term torque vectoring is also used in the automobile sector to refer to the distribution of torque.

A further preferred exemplary embodiment of the method is characterized in that a rear wheel on the outside of the bend is driven in a targeted manner with a greater driving torque during the maneuvering operation in order to reduce skewing of a front wheel on the outside of the bend. As a result, a phenomenon which is undesirable during maneuvering and is also referred to as parking judder can be prevented or at least reduced. The occurrence of undesirable noises during maneuvering is prevented in particular by the fact that an intermittent slipping of the front wheel on the outside of the bend is suppressed by the targeted increased driving of the rear wheel on the inside of the bend. The targeted changing of the driving torque is advantageously initiated with a vehicle-internal control system for distributing torque. The term torque vectoring is also used in the automobile sector to refer to the distribution of torque.

A further preferred exemplary embodiment of the method is characterized in that the front wheel on the outside of the bend is pulled onto a smaller curved path. A smaller curved path means, for example, that the front wheel on the outside of the bend is pulled onto a path or curved path having a smaller curve radius. This can be achieved by one of the previously described measures.

A further preferred exemplary embodiment of the method is characterized in that the front wheel on the inside of the bend is pulled onto a smaller curved path. The front wheel on the inside of the bend is advantageously also pulled onto a smaller curved path with at least one of the previously described measures. A smaller curved path also means here, for example, a path or a curved path having a smaller curve radius.

The invention furthermore relates to a driving dynamics control system for operating a motor vehicle according to a previously described method. The driving dynamics control system advantageously comprises suitable actuating devices for the targeted braking of one of the wheels.

The invention optionally also relates to a system for controlling the distribution of torque during operation of a motor vehicle according to a previously described method. By means of the system for controlling the distribution of torque, an individual wheel can be driven in a targeted manner with a lower or a greater driving torque.

The invention furthermore relates to a computer program product having a program code for carrying out a previously described method. The computer program is executed, for example, in a control unit of the motor vehicle, via which a previously described driving dynamics control system and/or a previously described system for controlling the distribution of torque during the maneuvering of the motor vehicle is actuated.

The invention furthermore relates to a control unit for controlling a driving dynamics control systems and/or for controlling a system for controlling the distribution of torque with a previously described computer program product.

The invention furthermore relates to a motor vehicle having a driving dynamics control system and/or having a system for controlling the distribution of torque and/or having a previously described control unit.

### BRIEF DESCRIPTION OF THE DRAWINGS

Further advantages, features and details of the invention emerge from the description below in which various exemplary embodiments are described in detail with reference to the drawing, in which:

FIG. 1 shows a simplified illustration of a motor vehicle with a chassis which comprises two front wheel and two rear wheels, during a maneuvering operation, and

FIG. 2 shows a similar illustration as in FIG. 1, wherein one of the wheels is influenced or manipulated in a targeted manner during the maneuvering operation in order to pull or to force the motor vehicle onto a smaller turning circle during the maneuvering.

### DETAILED DESCRIPTION OF THE INVENTION

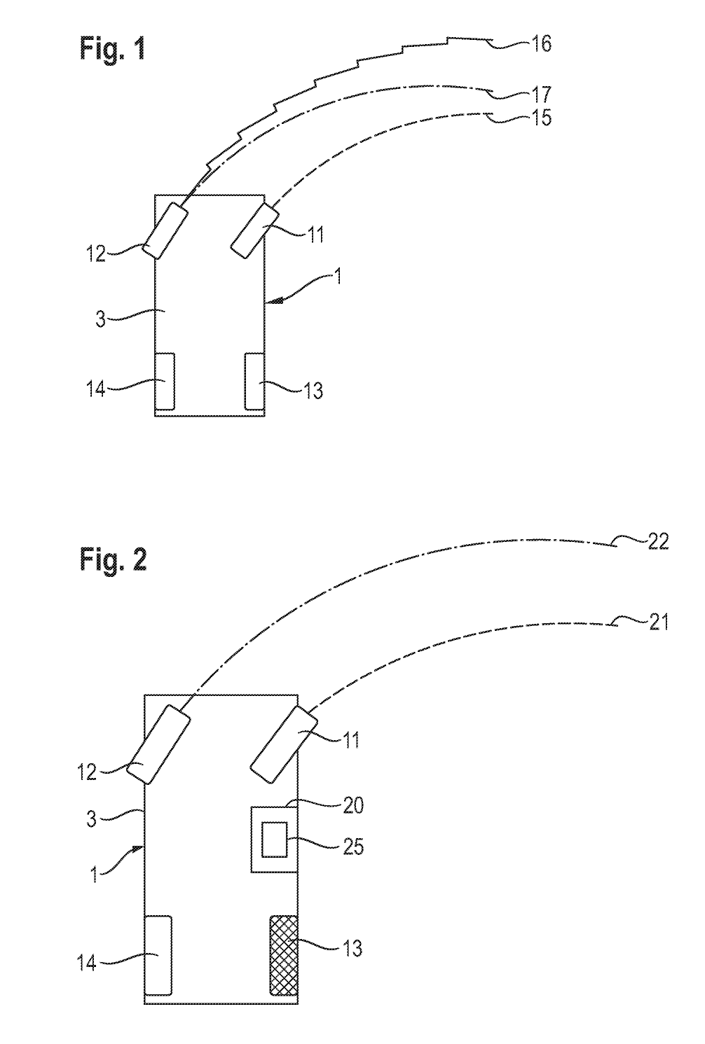

A motor vehicle 1 with a chassis 3 is illustrated in highly simplified form in FIGS. 1 and 2. The chassis 3 comprises two steerable front wheels 11, 12 and two non-steerable rear wheels 13, 14.

The front wheels 11, 12 of the motor vehicle 1 are turned to a large extent, in particular to a maximum extent, to the right for the purpose of maneuvering, in particular for entering or leaving a parking space, in FIGS. 1 and 2. In the top view illustrated, the front wheels 11, 12 are pivoted to the right relative to a vehicle longitudinal axis.

In FIG. 1, the front wheel 11 on the inside of the bend describes a curved path 15. The front wheel 12 on the outside of the bend describes a forced curved path 16. A theoretical curved path 17 of the front wheel 12 on the outside of the bend is indicated between the curved paths 15 and 16.

The motor vehicle 1 is preferably a sports car which has only a limited construction space in the region of the front axles for the wheel lock during steering. The construction space limitation is caused firstly by large tire widths. Furthermore, the construction space is limited by the wheel lock in a specification of the turning circle. Furthermore, the construction space is limited by a rectilinear design of longitudinal members of the vehicle body.

A constriction caused by the construction space limitation can be kept within limits, for example, by means of relatively low Ackermann portions. This gives rise, for example during parking, in particular under certain weather conditions, to undesirable tire noises, even to tire hopping.

In the tests, investigations and measurements carried out within the scope of the present invention, it has been shown that the front wheel 12 on the outside of the bend slips to a greater extent than the front wheel 11 on the inside of the bend. Steps in the curved path 15 are intended to illustrate a stick-slip effect which, within the context of the present invention, is considered to be a cause of the undesirable noises during parking. The stick-slip effect means that the front wheel 12 on the outside of the bend intermittently slips during maneuvering, in particular parking, while the front wheel 11 on the inside of the bend does not show this effect.

It is indicated in FIG. 2, by means of a rectangle 20, that the motor vehicle 1 is equipped with a driving dynamics control system 20. By means of the driving dynamics control system 20, the driving dynamics of the motor vehicle 1 in extreme situations can be influenced with a targeted braking of individual wheels. It has been discovered within the context of the present invention that, with the driving dynamics control system 20, during parking or maneuvering of the motor vehicle 1, the phenomenon previously referred to as parking judder can also be influenced.

If the rear wheel 13 on the inside of the bend is braked by the driving dynamics control system 20, the motor vehicle 1 is pulled onto a smaller turning circle and the skewing and hence the parking judder of the front wheel 12 on the outside of the bend are reduced. The precise parameters of the targeted braking interventions are stored, for example, in a control unit (likewise only indicated by a rectangle 25) in the motor vehicle 1. Alternatively or additionally, a driving torque of at least one individual wheel can be influenced or manipulated in a targeted manner.

It is indicated in FIG. 2 by a curved path 21 that the front wheel 11 on the inside of the bend is pulled onto a smaller turning circle if the rear wheel 13 on the inside of the curve is braked. It is indicated by means of a curved path 22 that the front wheel 12 on the outside of the bend is likewise particularly advantageously pulled onto a smaller path which is freer of skewing when the rear wheel 13 on the inside of the bend is braked.

What is claimed is:

1. A method for operating a motor vehicle which is equipped with a driving dynamics control system by which individual wheels of the motor vehicle are configured to be braked in a targeted manner, the method comprising:
influencing one of the individual wheels in a targeted manner in order to pull or to force the motor vehicle onto a smaller turning circle during a maneuvering operation in which two front wheels of the vehicle are turned with a large wheel lock causing friction at the front wheels because of ground contact.

2. The method as claimed in claim 1, wherein a rear wheel of the vehicle on an inside of a bend along a path travelled by the vehicle is braked in a targeted manner during the maneuvering process in order to reduce skewing of the front wheel on an outside of the bend.

3. The method as claimed in claim 1, wherein a rear wheel on an inside of a bend along a path travelled by the vehicle is driven in a targeted manner with a lower driving torque during the maneuvering operation in order to reduce skewing of a front wheel of the vehicle on an outside of the bend.

4. The method as claimed in claim 1, wherein a rear wheel on an outside of a bend along a path travelled by the vehicle is driven in a targeted manner with a greater driving torque during the maneuvering operation in order to reduce skewing of a front wheel of the vehicle on an outside of the bend.

5. The method as claimed in claim 1, wherein the front wheel of the vehicle on an outside of a bend along a path travelled by the vehicle is pulled onto the smaller turning circle.

6. The method as claimed in claim 1, wherein the front wheel of the vehicle on an inside of a bend along a path travelled by the vehicle is pulled onto the smaller turning circle.

7. A driving dynamics control system for operating a motor vehicle equipped with a driving dynamics control system by which individual wheels of the motor vehicle are configured to be braked in a targeted manner, the driving dynamics control system being configured to influence one of the individual wheels in a targeted manner in order to pull or to force the motor vehicle onto a smaller turning circle during a maneuvering operation in which two front wheels of the vehicle are turned with a large wheel lock causing friction at the front wheels because of ground contact.

8. A computer program product having a program code for operating the driving dynamics control system as claimed in claim 7.

9. A control unit for controlling the driving dynamics control system with the computer program product as claimed in claim 8.

10. A motor vehicle having a driving dynamics control system as claimed in claim 7.

11. A motor vehicle having a control unit as claimed in claim 9.
